(19) United States
(12) Patent Application Publication
(10) Pub. No.: US 2006/0108869 A1
(43) Pub. Date: May 25, 2006

(54) Electronic stability system-strategy to improve the stability performance in cold temperatures

(75) Inventors: Mile Jokic, Rochester Hills, MI (US); Hauke O. Schupp, Pontiac, MI (US); Christopher W. Deyer, Novi, MI (US)

Correspondence Address: CONTINENTAL TEVES INC.;C/O BRINKS HOFER GILSON & LIONE, P. O. BOX 10395, CHICAGO, IL, 60610, US

(73) Assignee: Continental Teves, Inc.

(21) Appl. No.: 10/993,390

(22) Filed: Nov. 19, 2004

(51) Int. Cl. B60T 8/32; B60T 13/66

(52) U.S. Cl. 303/191; 303/20

(57) ABSTRACT

The electronic stability control system includes a hydraulic braking system, a brake in communication with the hydraulic braking system, the controller configured to implement an electronic stability control strategy. The controller is further configured to determine a brake fluid temperature in the hydraulic braking system and modify the electronic stability strategy based on the brake fluid temperature.

### BACKGROUND

1. Field of the Invention

The present invention generally relates to an electronic stability control system for a motor vehicle. More specifically, the invention relates to an electronic stability control system configured to modify an electronic stability strategy based on brake fluid temperature.

2. Description of Related Art

Many of today's vehicles include braking systems with electronic stability control. Electronic stability control systems and more particularly, yaw control systems increase vehicle stability by measuring the amount of understeer or oversteer of the vehicle and correcting the vehicle to the desired path utilizing the braking system. Typically, electronic stability control systems will measure the vehicle speed, yaw rate, lateral acceleration and steering wheel position to determine if an understeer or oversteer condition exists. The system will then correct for the amount of understeer or oversteer by applying braking torque to one or more wheels to return the vehicle to the desired path. Other functions of electronic stability control systems include reducing the tendency of a vehicle to roll-over caused by steering inputs.

In low ambient temperatures, a disadvantage of hydraulically operated vehicle stability control systems is the increased viscosity of the brake fluid and the resulting degraded flow rate through the brake system. The degraded flow rate causes degraded stability performance due to the lower pressure build rates through the hydraulic system essentially providing a slower reaction time to correct the oversteer or understeer condition.

In view of the above, there exists a need for an improved electronic stability control system addressing the above described issues.

### SUMMARY OF THE INVENTION

In satisfying the above need, as well as overcoming the enumerated drawbacks and other limitations of the related art, the present invention provides an improved electronic stability control system.

The electronic stability control system includes a hydraulic braking system, a set of wheel brakes in communication with the hydraulic braking system, and a controller configured to implement an electronic stability control strategy. The electronic stability control strategy may include yaw control, roll control, and other vehicle control functions. The controller is further configured to determine a brake fluid temperature in the hydraulic braking system and modify the electronic stability strategy based on the brake fluid temperature.

In yet another aspect of the present invention, the controller is configured to calculate a brake fluid temperature model based on a plurality of vehicle parameters. The vehicle parameters may include a change in the temperature of engine coolant, a change in the temperature of engine oil, a change in the ambient temperature, the number of brake fluid pump events, the number of electronic stability control events, the number of traction control system events, and the number of antilock braking system events. The number of events are measured over a given time interval.

In yet another aspect of the present invention, the controller is configured to calculate a brake fluid temperature from a brake fluid model based on a low temperature trigger. The low temperature trigger may be based on an engine coolant temperature, an engine oil temperature, or an ambient temperature.

In another aspect of the present invention, the controller is configured to change electronic stability control parameters to decrease brake fluid pressure actuation time. To decrease the brake fluid pressure actuation time, the controller may lower electronic stability control thresholds and increase electronic stability control gain factors.

In yet another aspect of the present invention, the controller is configured to increase the monitoring rate of vehicle parameters based on the brake fluid temperature. The controller may increase the monitoring of the yaw rate, the yaw rate error, or the yaw rate error gradient of the vehicle. Additionally, the controller may also increase the frequency of brake fluid pump checks based on the brake fluid temperature. As such, the controller increases the brake fluid pressure to take up lost travel thereby cleaning the brake rotor and ensuring maximum friction is achieved.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a diagrammatic view of an electronic braking system in accordance with the present invention;

FIG. 2 is a control flow diagram of an electronic braking system according to the present invention;

FIG. 3 is a flow diagram of a brake fluid temperature model according to the present invention; and

FIG. 4a and 4b is a flow diagram of an electronic stability control strategy according to the present invention.

### DETAILED DESCRIPTION OF THE INVENTION

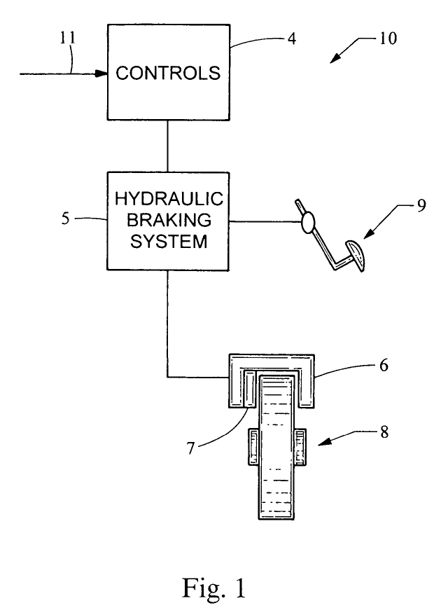

Referring now to FIG. 1, a system embodying the principles of the present invention is illustrated therein and designated at 10. The system 10 includes a controller 4, a hydraulic braking system 5, and a brake 6. The hydraulic braking system 5 receives input from a brake pedal 9 actuated by a vehicle driver and the controller 4. Based on the input from the brake pedal 9 and the controller 4, the hydraulic braking system 5 activates or de-activates the brake 6. The brake 6 is shown as a symbolic caliper brake having a brake pad 7 that contacts the rotor 8 thereby creating braking torque. The controller 4 also receives vehicle parameters 11 from other systems within the vehicle and is configured to implement a electronic stability control strategy based on the vehicle parameters 11.

To improve electronic stability control performance at low temperatures, the controller 4 is configured to determine the brake fluid temperature and modify the electronic stability control strategy based on the brake fluid temperature to increase vehicle performance at cold ambient temperatures. As such, the controller 4 is configured to recognize the ambient temperature based on a temperature trigger. At cold temperatures, for example below 0° C. , the trigger will be activated, further the trigger may have an accuracy of ± 5° C. The temperature trigger may also be inferred or calculated using the vehicle information found on the vehicle communication bus. Reliable information for generating the trigger may include engine coolant temperature, engine oil temperature, and ambient temperature.

After the cold temperature condition is recognized via the temperature trigger, the controller 4 is configured to calculate the thermal behavior of the fluid based on one or more of various vehicle parameters 11. The vehicle parameters 11 upon which the brake fluid model is based on may include but is not limited to the change in engine coolant temperature, the change in engine oil temperature, the change in ambient temperature, pump check events, electronic stability control events, traction control system events, antilock braking system events, or pedal applies. In addition, any of the mentioned brake application events may be further analyzed based on the rate and absolute pressure level, as well as, the duration of the braking event.

Based on the brake fluid temperature calculated from the brake fluid temperature model, the electronic stability control strategy in the controller 4 may be changed to improve brake pressure actuation time at the rotor 8. These strategy changes will be used to overcome the higher viscosity of brake fluid at cold temperatures and produce earlier build pressures than during normal operation. Therefore, the base electronic stability control oversteer and understeer thresholds must be lowered for earlier recognition of vehicle instability. Accordingly, the electronic stability control strategy will start building pressure earlier to account for the higher viscosity of the brake fluid. In addition, the controller 4 will monitor the stabilizing parameters, such as yaw rate, yaw rate error, and yaw rate error gradient more frequently. In addition, the controller 4 will perform pump checks more regularly to move brake fluid and use internal friction to warm up the fluid. The controller 4 may also be used to periodically build pressure to the brakes to take up lost travel between the brake pad 7 and rotor 8 and periodically clean the rotor 8 to provide maximum performance.

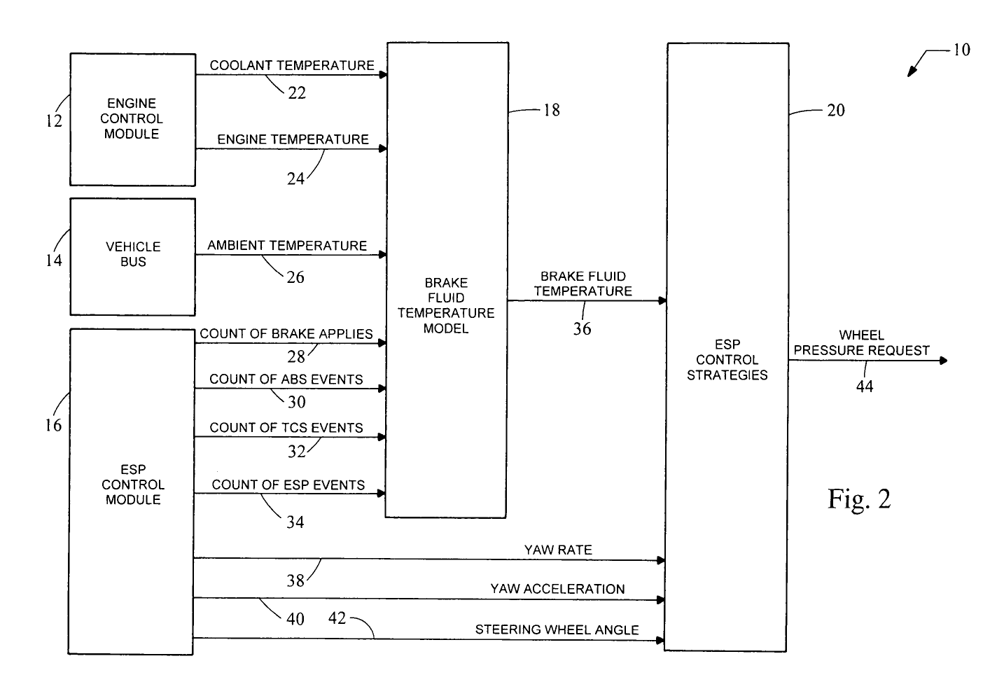

Now referring to FIG. 2, a diagram of the electronic stability control system is provided. The electronic stability control system 10 receives input from the engine control module 12, the vehicle bus 14, and the electronic stability control module 16. These vehicle parameters are provided to a brake fluid temperature model as denoted by block 18 to generate a brake fluid temperature 36. The brake fluid temperature model 18 may generate the brake fluid temperature 36 based on a number of various vehicle parameters. The vehicle parameters may include one or more of the engine coolant temperature 22 and the engine temperature 24 provided from the engine control module 12, the ambient temperature 26 provided from the vehicle bus 14, and the count of brake applies 28, the count of antilock braking system (ABS) events 30, the count of traction control system (TCS) events 32, and the count of electronic stability control (ESC) events 34 from the electronic stability control module 16.

The brake fluid temperature 36 is provided from the brake fluid temperature model 18 to the electronic stability control strategy 20. The electronic stability control strategy 20 utilizes the brake fluid temperature 36 and one or more of the yaw rate 38, the yaw acceleration 40, and the steering wheel angle 42 provided by the electronic stability control module 16, to generate a wheel pressure request 44 to control one or more brakes connected to the hydraulic braking system.

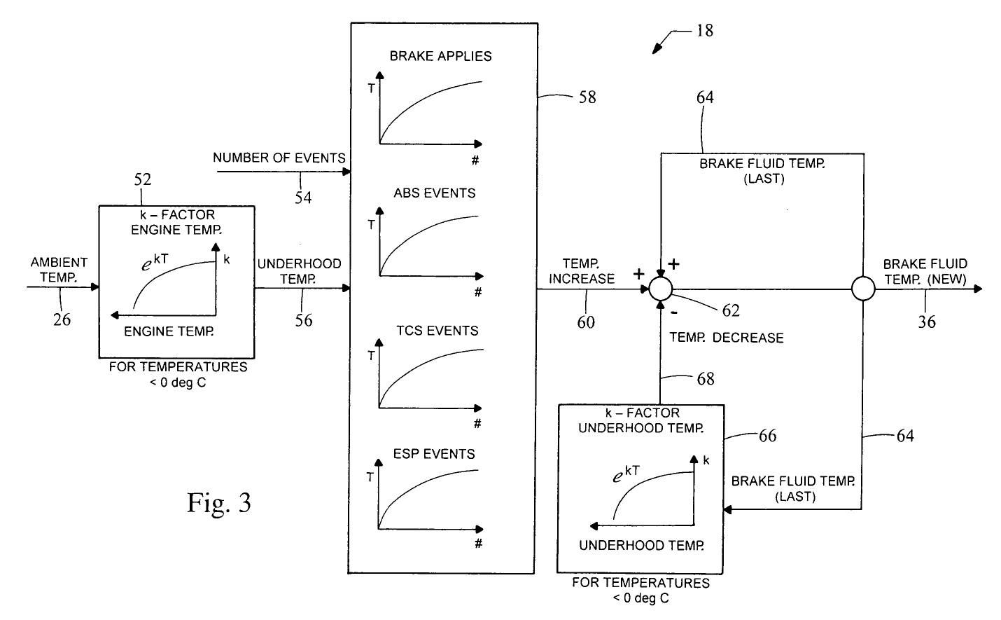

Now referring to FIG. 3, a diagrammatic view of the brake fluid temperature model 18 is provided in more detail. The ambient temperature 26 is provided to block 52 to estimate an under hood temperature 56. Although the block 52 is shown as using the ambient temperature 26, alternatively, the coolant temperature 22 or engine temperature 24 may also be used. The under hood temperature 56 and the number of braking events 54, such as brake applies, ABS events, TCS events, and electronic stability control events are used in block 58 to calculate a temperature increase 60 generated in the brake fluid due to the braking events 54. Summer 62 receives the temperature increase 60 and is used as a feedback node. As such, the last brake fluid temperature 64 is provided to block 66 to determine an estimated under hood temperature decrease 68. The last brake fluid temperature 64, the temperature decrease 68 and the temperature increase 60 are provided to summer 62 to estimate the brake fluid temperature 36 at the current time.

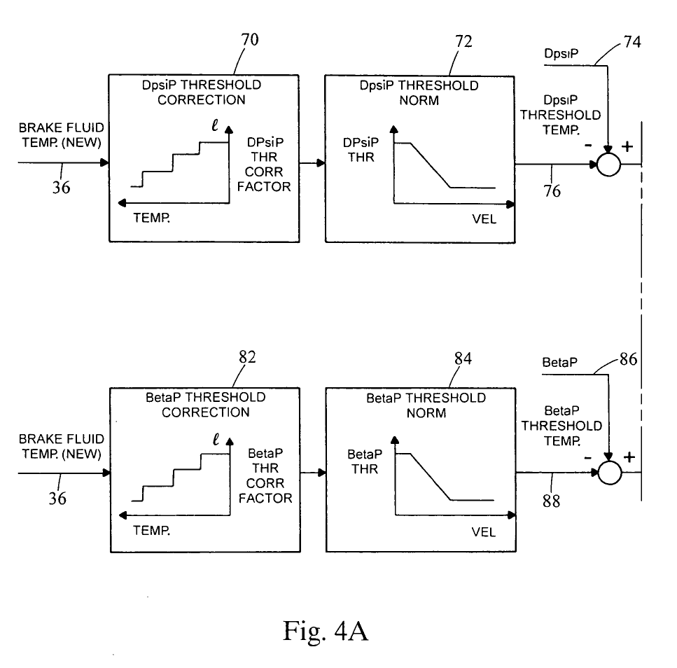

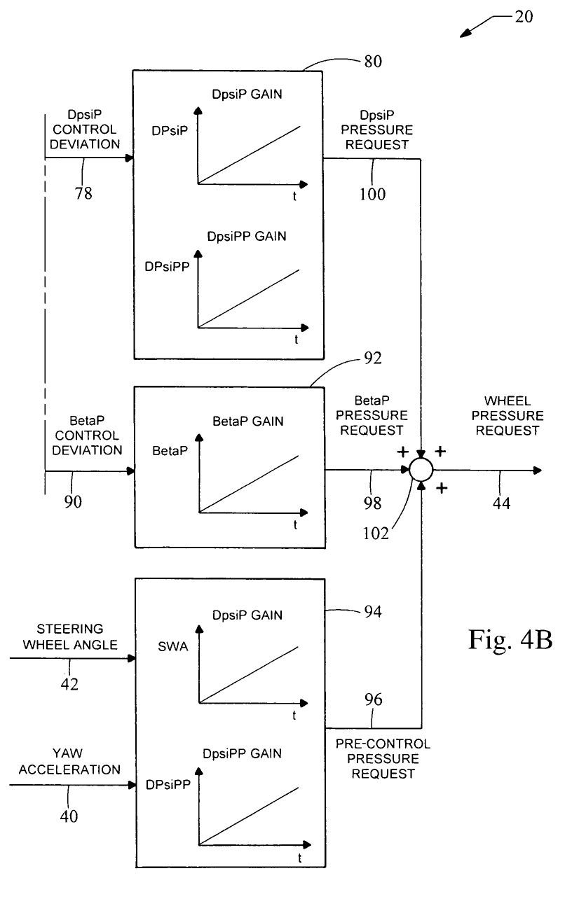

Now referring to FIGS. 4a and 4b, a diagrammatic view of the electronic control strategy 20 is provided in more detail. The electronic stability control strategy 20 includes a yaw control sequence 71 and a body side slip angle gradient control sequence 81, and a situation control sequence 94. The brake fluid temperature 36 is provided to block 70 of the yaw control sequence 71. Block 70 determines a DPSIP threshold correction factor based on the brake fluid temperature 36. DPSIP corresponds to the time derivative of the yaw rate. The DPSIP threshold correction factor is provided from block 70 to block 72 and is used to adjust a DPSIP normal threshold that varies with respect to vehicle velocity. The DPSIP threshold 76 is compared with the DPSIP 74, that may be provided from a yaw rate sensor to generate a DPSIP control deviation 78 (or yaw rate error). The DPSIP control deviation 78 is provided to block 80 to calculate a DPSIP gain and a DPSIPP yaw acceleration gain based on the brake fluid temperature to generate a DPSIP pressure request 100. This is accomplished by using a standard proportional integral derivative controller.

The brake fluid temperature 36 is provided to block 82 of the body side slip angle gradient control sequence 81. Block 82 determines a Beta P threshold correction factor based on the brake fluid temperature 36. Beta P corresponds to the body side slip angle gradient. The Beta P threshold correction factor is provided from block 82 to block 84 and is used to adjust a Beta P threshold that varies with respect to vehicle velocity. The Beta P threshold 88 is compared with the Beta P 86, that may be calculated from the yaw rate sensor, lateral acceleration sensor, and steering wheel angle sensor to generate a Beta P control deviation 90. The Beta P control deviation 90 is provided to block 92 to calculate a Beta P gain with respect to time. The Beta P gain is used to generate a Beta P pressure request 98.

The steering wheel angle 42 and yaw acceleration 40 is provided to a situational control block 94. The DPSIP gain is applied to the steering wheel angle with respect to time and combined with the DPSIPP gain with respect to time to generate a pre-controlled pressure request 96. The DPSIP pressure request 100, the Beta P pressure request 98, and the pre-controlled pressure request 96 are provided to summer 102 to generate a wheel pressure request 44 to actuate the hydraulic braking system, in accordance with the modified electronic stability control strategy based upon the brake fluid temperature.

As a person skilled in the art will readily appreciate, the above description is meant as an illustration of implementation of the principles of this invention. This description is not intended to limit the scope or application of this invention in that the invention is susceptible to modification, variation and change, without departing from spirit of this invention, as defined in the following claims.

I/We claim:

1. An electronic stability control system comprising:
a hydraulic braking system;
at least one brake in communication with the hydraulic braking system;
a controller in communication with the hydraulic braking system and configured to implement an electronic stability control strategy, the controller further being configured to determine a brake fluid temperature and modify the electronic stability control strategy based on the brake fluid temperature.

2. The system according to claim 1, wherein the controller is configured to calculate the brake fluid temperature from a brake fluid temperature model based on at least one vehicle parameter.

3. The system according to claim 2, wherein the controller is configured to calculate the brake fluid temperature from a brake fluid temperature model based on a change in the temperature of engine coolant.

4. The system according to claim 2, wherein the controller is configured to calculate the brake fluid temperature from a brake fluid temperature model based on a change in the temperature of engine oil.

5. The system according to claim 2, wherein the controller is configured to calculate the brake fluid temperature from a brake fluid temperature model based on a change in ambient temperature.

6. The system according to claim 2, wherein the controller is configured to calculate the brake fluid temperature from a brake fluid temperature model based on brake fluid pump check events.

7. The system according to claim 2, wherein the controller is configured to calculate the brake fluid temperature from a brake fluid temperature model based on electronic stability control events.

8. The system according to claim 2, wherein the controller is configured to calculate the brake fluid temperature from a brake fluid temperature model based on traction control system events.

9. The system according to claim 2, wherein the controller is configured to calculate the brake fluid temperature from a brake fluid temperature model based on antilock braking system events.

10. The system according to claim 2, wherein the controller is configured to calculate the brake fluid model based on a low temperature trigger.

11. The system according to claim 10, wherein the low temperature trigger is based on an engine coolant temperature.

12. The system according to claim 11, wherein the low temperature trigger is determined based on an engine oil temperature.

13. The system according to claim 11, wherein the low temperature trigger is determined based on an ambient temperature.

14. The system according to claim 1, wherein the controller is configured to change electronic stability control parameters to decrease brake fluid pressure actuation time.

15. The system according to claim 14, wherein the controller is configured to lower electronic stability control thresholds to decrease brake fluid pressure actuation time.

16. The system according to claim 14, wherein the controller is configured to increase electronic stability control gain factors to decrease brake fluid pressure actuation time.

17. The system according to claim 1, wherein the controller is configured to increase a monitoring rate of vehicle parameters based on the brake fluid temperature.

18. The system according to claim 17, wherein the controller is configured to increase a rate of yaw rate monitoring based on the brake fluid temperature.

19. The system according to claim 17, wherein the controller is configured to increase a rate of yaw rate error monitoring based on the brake fluid temperature.

20. The system according to claim 17, wherein the controller is configured to increase a rate of yaw rate error gradient monitoring based on the brake fluid temperature.

21. The system according to claim 1, wherein the controller is configured to increase a frequency of brake fluid pump checks based on the brake fluid temperature.

22. The system according to claim 1, wherein the controller is configured to increase a brake fluid pressure to take up lost travel thereby cleaning the rotor.
